(19) United States
(12) Patent Application Publication
(10) Pub. No.: US 2026/0203970 A1
(43) Pub. Date: Jul. 16, 2026

(54) SYSTEM AND METHOD FOR RENDERING A WELLBORE TRAJECTORY LOG

(71) Applicant: SCHLUMBERGER TECHNOLOGY CORPORATION, Sugar Land, TX (US)

(72) Inventor: Thibaut ANDRIEU, Montpellier (FR)

(21) Appl. No.: 19/136,319

(22) PCT Filed: Dec. 15, 2022
(86) PCT No.: PCT/US2022/081653

§ 371 Date: Jun. 6, 2025

(51) Int. Cl. G06T 11/26; G06T 1/20; G06T 7/50; G06T 7/73; G06T 11/10

(52) U.S. Cl. CPC G06T 11/26; G06T 1/20; G06T 7/50; G06T 7/73; G06T 11/10

(57) ABSTRACT

A method includes receiving well log data with a central processing unit (CPU). The well log data is captured by a 2024/129125 downhole tool in a wellbore. The well log data includes a first parameter and a second parameter. The first parameter is a trajectory of the wellbore. The method also includes transmitting the well log data from the CPU to a graphics processing unit (GPU). The method also includes generating a line representing the trajectory of the wellbore using the GPU. The line is based upon the first parameter. The method also includes generating a ribbon using the GPU based upon the first parameter and the second parameter.

### BACKGROUND

A well log (also referred to as well log data) includes measurements captured by a downhole tool in a wellbore. The measurements are of one or more parameters in and/or around a wellbore. The measurements correspond to depth, time, or both. The well log data can be represented by a 2D ribbon following the wellbore trajectory in 3D space. Conventional rendering methods are based on texture generation by a central processing unit (CPU). The texture is then mapped on a mesh 3D model along with the trajectory by the CPU. The texture and mesh 3D model are then transmitted from the CPU to a graphics processor unit (GPU). To achieve acceptable quality, the generated texture has a certain resolution, which consumes a certain amount of GPU memory. This constraint prevents the usage of this kind of visualization when displaying 2D ribbons for a plurality of wellbores.

### SUMMARY

A method is disclosed. The method includes receiving well log data with a central processing unit (CPU). The well log data is captured by a downhole tool in a wellbore. The well log data includes a first parameter and a second parameter. The first parameter is a trajectory of the wellbore. The method also includes transmitting the well log data from the CPU to a graphics processing unit (GPU). The method also includes generating a line representing the trajectory of the wellbore using the GPU. The line is based upon the first parameter. The method also includes generating a ribbon using the GPU based upon the first parameter and the second parameter.

A computing system is also disclosed. The computing system includes one or more processors and a memory system including one or more non-transitory computer-readable media storing instructions that, when executed by at least one of the one or more processors, cause the computing system to perform operations. The operations include receiving well log data with a central processing unit (CPU). The well log data is captured by a downhole tool in a wellbore. The well log data includes a first parameter and a second parameter. The first parameter is a trajectory of the wellbore. The second parameter includes temperature, pressure, resistivity, porosity, gamma ray, sonic velocity, or a combination thereof in the wellbore. The operations also include transmitting the well log data from the CPU to a graphics processing unit (GPU). The operations also include generating a line representing the trajectory of the wellbore using the GPU. The line is based upon the first parameter. The operations also include generating a two-dimensional (2D) ribbon using the GPU. Generating the 2D ribbon includes generating a space using a geometry shader running on the GPU. The space is adjacent to the line. The space is determined based upon the first parameter. Generating the 2D ribbon also includes generating a visual indicator using a fragment shader running on the GPU. The visual indicator is positioned within the space. The visual indicator is based upon the second parameter.

A computer program is also disclosed. The computer program includes instruction that, when executed by a computer processor of a computing device, cause the computing device to perform operations. The operations include receiving well log data with a central processing unit (CPU). The well log data is captured by one or more downhole tools in a plurality of wellbores. The well log data includes a first parameter and a second parameter. The first parameter includes trajectories of the wellbores. The second parameter includes temperature, pressure, resistivity, porosity, gamma ray, sonic velocity, or a combination thereof in the wellbores. The operations also include transmitting the well log data from the CPU to a graphics processing unit (GPU). The CPU does not generate a texture or a model based upon the well log data before transmitting the well log data to the GPU, thereby reducing an amount of memory used by the GPU. The operations also include generating a plurality of first lines representing the trajectories of the wellbores using the GPU. The first lines are based upon the first parameter. The operations also include generating a plurality of two-dimensional (2D) ribbons using the GPU. Generating the 2D ribbons includes generating a plurality of spaces using a geometry shader running on the GPU. Each space is adjacent to a corresponding one of the first lines. The spaces are determined based upon the first parameter. A top left foremost point of each space has first coordinates (0, 0) in a ribbon coordinate system. A bottom right foremost point of each space has second coordinates (maxMD, max Value) in the ribbon coordinate system. The variable maxMD is a maximum measured depth, and the variable max Value is a maximum value of the second parameter. Generating the 2D ribbons also includes generating a plurality of second lines using a fragment shader running on the GPU. Each second line is positioned within a corresponding one of the spaces. The second lines are based upon the second parameter. Generating each second line includes determining corresponding coordinates in the ribbon coordinate system for a pixel in the space. Generating each second line also includes determining a measured depth of the pixel and a value of the pixel in the space based upon the corresponding coordinates in the ribbon coordinate system. Generating each second line also includes determining a value of the second parameter for the pixel based upon the measured depth of the pixel and the value of the pixel in the space. Generating each second line also includes generating a color for the pixel based upon a comparison of the value of the pixel and the value of the second parameter at the measured depth of the pixel. Generating the color includes generating a first color in response to the value of the pixel being equal to the value of the second parameter or generating a second color in response to the value of the pixel being different than the value of the second parameter. The first color forms a part of the second line. The second color does not form the part of the second line.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4A illustrates a schematic view of a method for rendering and displaying well log data as a 2D ribbon that follows a 3D wellbore trajectory, according to an embodiment.

FIG. 4B illustrates a schematic view of another method for rendering and displaying well log data as a 2D ribbon that follows a 3D wellbore trajectory, according to an embodiment.

FIG. 5 illustrates a graph showing the memory used by the GPU that implements the methods in FIGS. 4A and 4B, according to an embodiment.

FIG. 6 illustrates a flowchart of a method for rendering and displaying well log data as a 2D ribbon that follows a 3D wellbore trajectory, according to an embodiment.

FIG. 7 illustrates a schematic side view of a wellbore formed in a subterranean formation, according to an embodiment.

FIG. 8 illustrates an example of well log data captured by a downhole tool in the wellbore, according to an embodiment.

FIG. 9A illustrates a 2D ribbon in wireframe, and FIG. 9B illustrates a 2D ribbon that is blank (e.g., white space), according to an embodiment.

FIG. 10 illustrates a schematic view of a 2D ribbon coordinate system, according to an embodiment.

FIG. 11 illustrates a well log plotted on a 2D ribbon next to a wellbore trajectory, according to an embodiment.

FIG. 12 illustrates a 2D ribbon showing a colormap render style, according to an embodiment.

FIG. 13 illustrates a 2D ribbon showing a solid curve render style, according to an embodiment.

FIG. 14 illustrates a 2D ribbon showing combined render styles, according to an embodiment.

FIG. 15 illustrates a plurality of 3D wellbore trajectories with each having a 2D ribbon next to it, according to an embodiment.

FIG. 16 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding embodiments of the invention. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of embodiments of the invention. The first object and the second object are both objects, respectively, but they are not to be considered the same object.

The terminology used in the description of embodiments of the invention herein is for the purpose of describing particular embodiments only and is not intended to be limiting of embodiments of the invention. As used in the description of embodiments of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

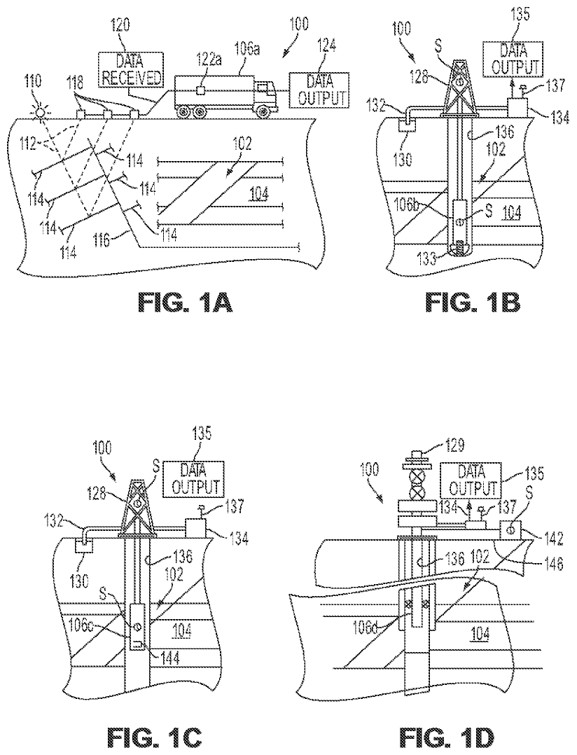

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Rendering and/or displaying of wellbore trajectories and corresponding 2D ribbons that are based upon the well log data from 1000 (or more) wellbores using less than 1 GB of GPU memory are described herein. The method may be used on a computing system, a smart phone, an embedded device, or the like. More particularly, the system and method described herein enable a rendering technique to display well log data in the form of a 2D ribbon that follows a 3D wellbore trajectory. As described below, a shader approach is used to produce the final ribbon image on-the-fly without having to store texture and/or a model (e.g., a mesh 3D model) on the GPU memory. This enables the trajectories and corresponding 2D ribbons from a plurality of wellbores to be rendered and/or displayed at the same time and minimizes memory requirements.

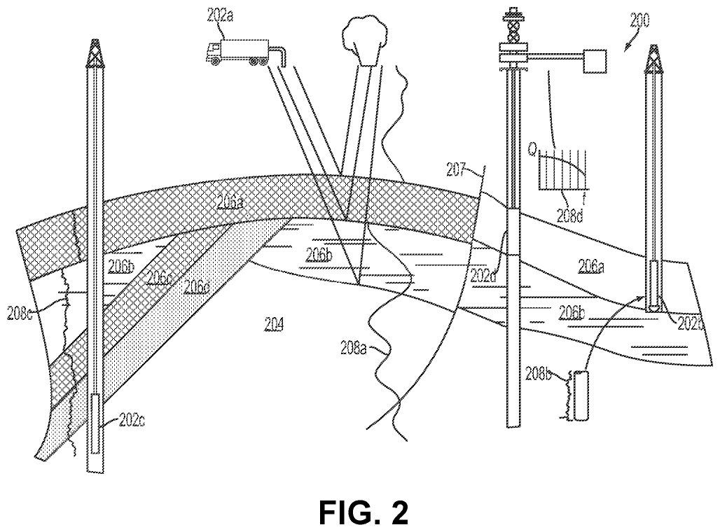

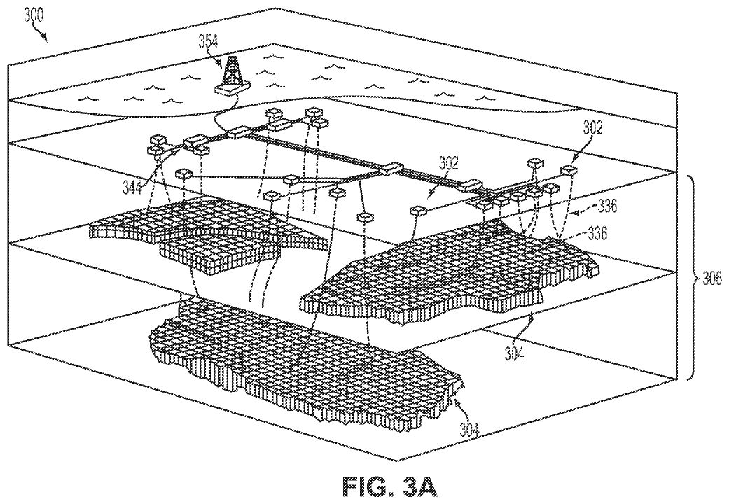

FIG. 4A illustrates a schematic view of a method for rendering and displaying well log data as a 2D ribbon that follows a 3D wellbore trajectory, according to an embodiment. As shown, the method in FIG. 4A includes transmitting well log data 410 to a CPU 420. The CPU 420 generates texture and/or a model (e.g., a mesh 3D model) 425 based upon the well log data 410. The texture and/or model (e.g., a mesh 3D model) 425 is then transmitted from the CPU 420 to a GPU 430. The GPU 430 then renders a wellbore trajectory and 2D ribbon 445 on a display (e.g., a screen or monitor) 440 based upon the texture and/or model 425.

A well field may include tens, hundreds, or thousands of wellbores. Using conventional techniques to render and/or display wellbore trajectories and corresponding 2D ribbons that are based upon the well log data from 1000 wellbores may use about 7 gigabytes (GB) of GPU memory. Currently, most GPUs have from about 4 GB memory to about 16 GB memory. In an example, the well log data may include about 10,000 values. Using one pixel per value along a vertical axis, 256 pixels for a horizontal axis, and red-green-blue (RGB) 8 bits texture, the memory used by the GPU 430 for a single well log is 10,000* 256* 3=7 megabytes (MB) GPU memory.

FIG. 4B illustrates a schematic view of another method for rendering and displaying well log data as a 2D ribbon that follows a 3D wellbore trajectory, according to an embodiment. As shown, the CPU 420 does not generate the texture and/or model 425 based upon the well log data 410. Rather, the CPU 420 transmits the raw well log data 410 to the GPU 430, and the GPU 430 generates the screen pixels 426 based upon the well log data 410. This may reduce the amount of memory used by the GPU 430. For example, in a scenario with 10,000 32-bit floating-point values, the method in FIG. 4B may use 10,000* 4=40 kilobytes (KB) GPU memory.

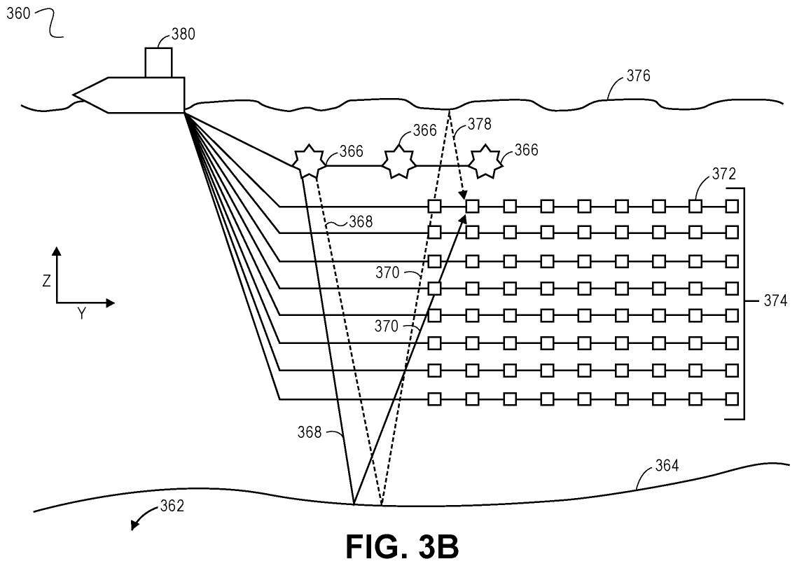

FIG. 5 illustrates a graph showing the memory used by the computing system (e.g., the GPU 430) that implements the methods in FIGS. 4A and 4B, according to an embodiment. As shown, the method used in FIG. 4B uses less GPU memory. This enables the GPU 430 to process well log data 410 from a plurality of wellbores and/or to render a plurality of wellbore trajectories and 2D ribbons 445. For some embodiments, the techniques described herein enables the GPU 430 to process well log data 410 from a plurality of wellbores at or about the same time and/or to render a plurality of wellbore trajectories and 2D ribbons 445 at or about the same time.

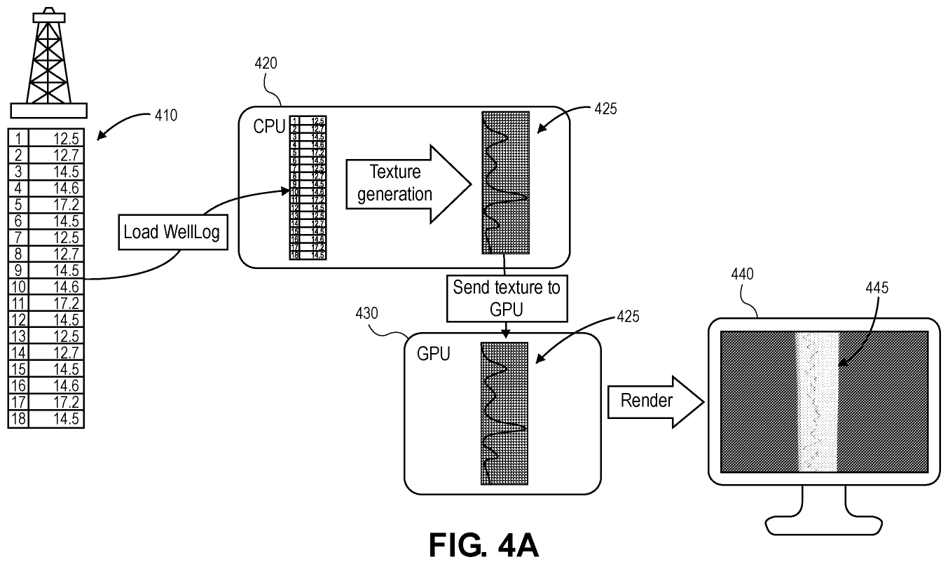

FIG. 6 illustrates a flowchart of a method 600 for rendering and/or displaying well log data as a 2D ribbon that follows a 3D wellbore trajectory, according to an embodiment. An illustrative order of the method 600 is provided below; however, one or more portions of the method 600 may be performed in a different order, combined, repeated, or omitted. Although the method 600 is described (for simplicity/clarity) using well log data 410 from a single wellbore to determine/generate a single first line and a single ribbon, it will be appreciated that the method 600 may also or instead use well log data 410 from a plurality of wellbores to (e.g., simultaneously) determine/generate a plurality of first lines and a plurality of corresponding ribbons.

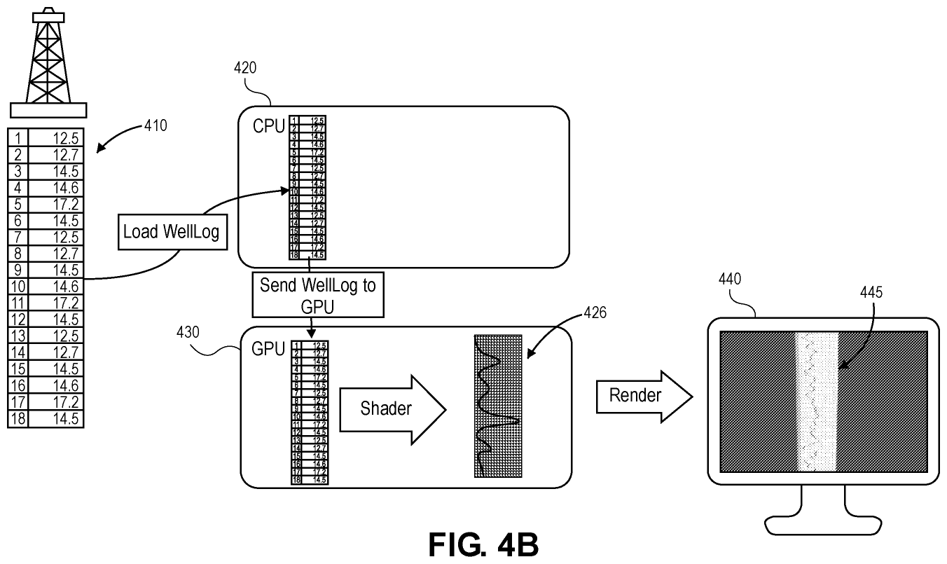

The method 600, in some examples, includes receiving well log data 410, as at 610. The well log data 410 may be measured by a downhole tool 710 in a wellbore 700, as illustrated in FIG. 7. The wellbore 700 may be drilled by the downhole tool 710. As described below, the downhole tool 710 may be configured to the measure well log data 410 in and/or around the wellbore 700. For example, the downhole tool 710 may include a measurement-while-drilling (MWD) tool and/or a logging-while-drilling tool. The MWD tool may be configured to measure physical parameters such as wellbore trajectory, temperature, and pressure. The LWD tool may be configured to measure formation parameters such as resistivity, porosity, sonic velocity, and gamma ray. The downhole tool 710 (and/or equipment at the surface) may also be configured to measure the depth (referred to as the measured depth) of the wellbore 700 and/or the downhole tool 710 therein. As shown, the depth is measured along the trajectory of the wellbore 700.

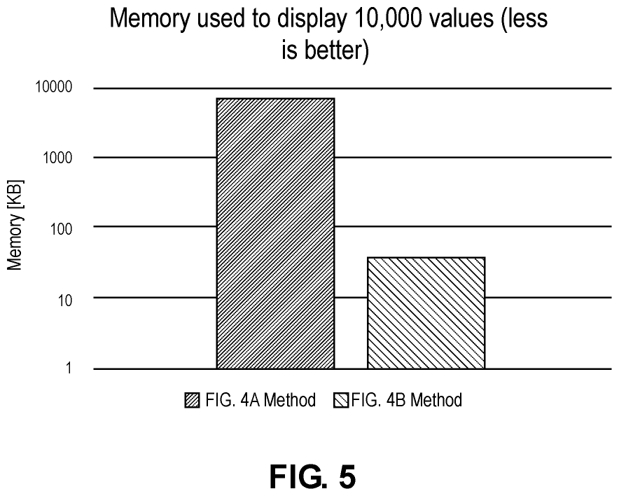

FIG. 8 illustrates an example of the well log data 410 captured by the downhole tool 710 in the wellbore 700, according to an embodiment. The well log data 410 may include a set of values that have been measured by the downhole tool 710 along the wellbore trajectory. As mentioned above, the well log data 410 (e.g., the values) may be or include wellbore trajectory, temperature, pressure, resistivity, porosity, sonic velocity, gamma ray, and/or any other downhole parameter. A one-dimensional (1D) log may have a single value measured for a given measured depth (MD). The 1D well log maps a plurality of values to corresponding MD positions. The well log may be defined as a function. For example, log value=temperature=ƒ(MD).

The well log data 410 may be transmitted from the downhole tool 710 and received by the CPU 420 of a computing system. The well log data 410 may include a first parameter and a second parameter. The first parameter may be or include the trajectory of the wellbore. The second parameter may be or include temperature, pressure, resistivity, porosity, gamma ray, sonic velocity, or a combination thereof in the wellbore.

Referring back to FIG. 6, the method 600 may also include transmitting the well log data 410 from the CPU 420 to the GPU 430, as at 620. The CPU 420, in some examples, does not generate a texture or a model (e.g., the mesh 3D model 425) based upon the well log data 410 before transmitting the well log data 410 to the GPU 430. This reduces the amount of memory used by the GPU 430. As a result, the GPU 430 processes the well log data 410 from a plurality (e.g., 1000) wellbores in a more efficient manner. For some embodiments, the GPU 430 processes the well log data 410 from a plurality (e.g., 1000) wellbores at or about the same time. This may also help the GPU 430 to render a plurality of wellbore trajectories and 2D ribbons 445 at or about the same time on a display 440, as described below.

The method 600 includes generating a first line representing the trajectory of the wellbore, as at 630. For some embodiments, the first line may be generated using the GPU 430 and minimizing the use of the CPU 420. In some embodiments, the first line is not generated using the CPU 420. The first line may be based upon a first parameter (such as those described herein, e.g., the wellbore trajectory). The first line may or may not be based upon a second parameter (such as those described herein).

The method 600 also includes generating a ribbon, as at 640. The ribbon may be two-dimensional (2D) or three-dimensional (3D). The ribbon may be generated using the GPU 430 and minimizing the use of the CPU 420. In some embodiments, the ribbon is not generated using the CPU 420. The ribbon may be based upon the first parameter, the second parameter, or both.

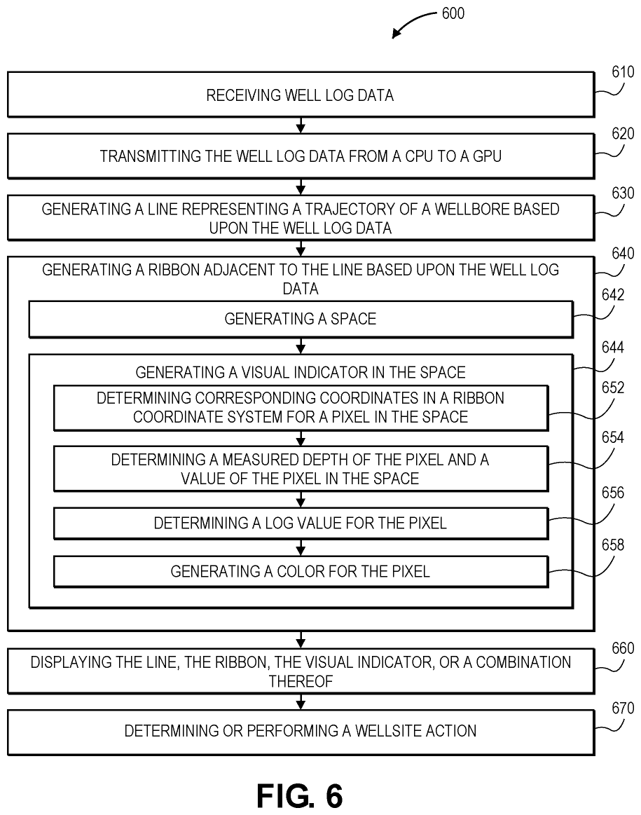

FIG. 9A illustrates a first line (also referred to as a trajectory line) 910 and a corresponding 2D ribbon 920 in wireframe, and FIG. 9B illustrates the first line 910 and the corresponding 2D ribbon 920 that is blank (e.g., white space), according to an embodiment. The ribbon 920 may be or include a space, as described below. The ribbon/space 920 may be adjacent to (e.g., side-by-side with) the first line 910.

Generating the ribbon 920, according to an example, includes generating a space, as at 642. The space is generated using a geometry shader running on the GPU 430 in some examples. The space may be at least partially within the ribbon 920. In some examples, the space is adjacent to the first line 910. The space may be determined based upon the first parameter (e.g., trajectory). The space may or may not be determined based upon the second parameter.

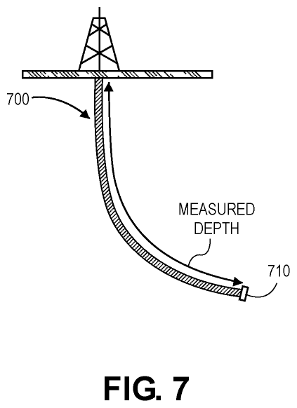

FIG. 10 illustrates a schematic view of a 2D ribbon coordinate system 1000, according to an embodiment. A top left foremost point of the space has first coordinates (0, 0) in the ribbon coordinate system 1000. A bottom right foremost point of the space has second coordinates (maxMD, max Value) in the ribbon coordinate system 1000. The value maxMD is a maximum measured depth in the wellbore 700, and the value max Value is a maximum value of the second parameter.

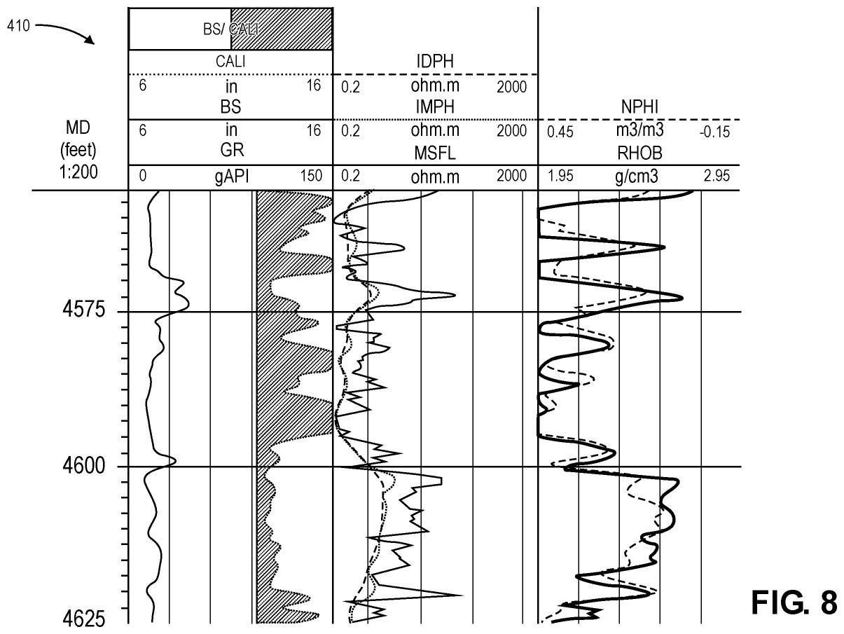

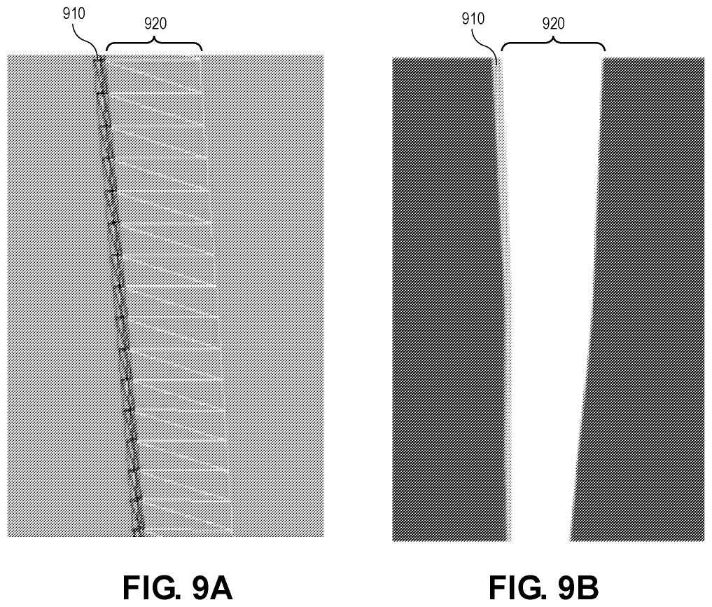

Generating the ribbon 920, in some examples, includes generating a visual indicator 930, as at 644. FIG. 11 illustrates the first line 910 and the 2D ribbon (e.g., the space) 920 with the visual indicator 930 therein, according to an embodiment. The visual indicator 930, according to an example, is generated using a fragment shader running on the GPU 430. The visual indicator 930 may be positioned within the space. The visual indicator 930 may be based upon the second parameter. The visual indicator 930 may or may not be based upon the first parameter (e.g., trajectory). The visual indicator 930 may be or include a line (e.g., a second line), a curve, a color, or a combination thereof (e.g., as shown in FIGS. 12-14).

Generating the visual indicator 930, in some examples, includes determining corresponding coordinates in the ribbon coordinate system 1000 for a pixel (e.g., each pixel) in the space, as at 652.

Generating the visual indicator 930, in some examples, also includes determining a measured depth (MD) of the pixel and a value of the pixel (also referred to as a pixel value) in the space, as at 654. The MD and/or the pixel value may be determined/generated based upon the corresponding coordinates in the ribbon coordinate system 1000.

Generating the visual indicator 930 may also include determining a value of the second parameter for the pixel, as at 656. This may also be referred to as a log value or a second parameter value. The log value may be determined/generated based upon the measured depth of the pixel, the pixel value, the log value at the pixel's measured depth, or a combination thereof.

Generating the visual indicator 930, in some examples, also includes generating a color for the pixel, as at 658. The color is determined/generated based upon the pixel value. The color may also or instead be determined/generated based upon a comparison of the pixel value and the log value at the pixel's measured depth. Generating the color, in some examples, includes generating a first color (e.g., black) in response to the pixel value being equal to the log value. Generating the color may also or instead include generating a second color (e.g., white) in response to the pixel value being different than the log value. The first color may form a part of the visual indicator (e.g., second line) 930. The second color may not form a part of the visual indicator (e.g., second line) 930. The second color may be the same as the color of the space.

The method 600, in some examples, also includes displaying the first line 910, the 2D ribbon 920, the visual indicator 930, or a combination thereof (e.g., on the display 440), as at 660.

The method 600 also includes determining or performing a wellsite action, as at 670. The wellsite action may be determined or performed based at least partially upon the first line 910, the ribbon 920, the visual indicator 930, or a combination thereof. In some embodiments, performing the wellsite action includes generating and/or transmitting a signal (e.g., using the computing system 1600) which instructs or causes a physical action to take place. In other embodiments, performing the wellsite action includes physically performing the action (e.g., either manually or automatically). Illustrative physical actions may include, but are not limited to, selecting a location to drill a wellbore, determining risks while drilling the wellbore, drilling the wellbore, varying a trajectory of the wellbore, varying a weight on the bit of a downhole tool that is drilling the wellbore, or a combination thereof.

FIG. 12 illustrates the first line 910 and the 2D ribbon (e.g., the space) 920 with the visual indicator 930 therein, according to an embodiment. The 2D ribbon (e.g., the space) 920 and/or the visual indicator 930 are shown here in a colormap render style.

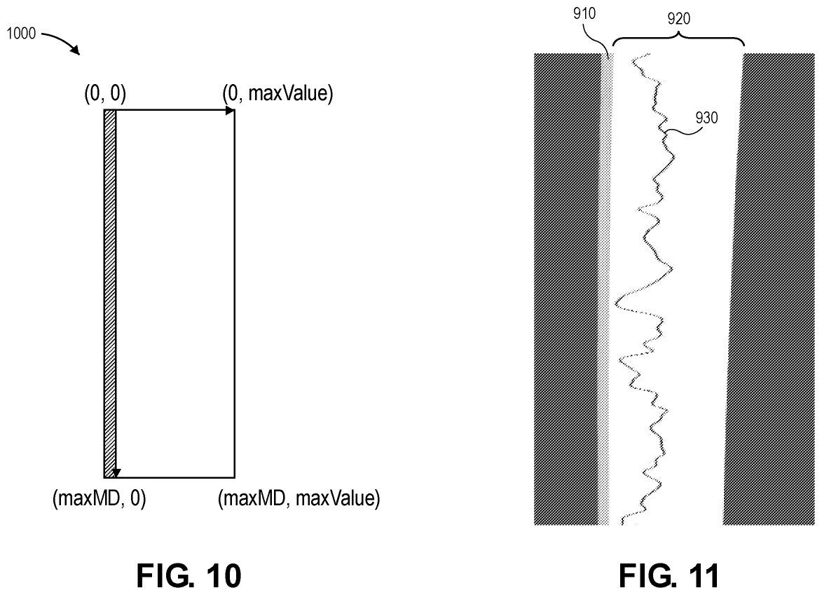

FIG. 13 illustrates the first line 910 and the 2D ribbon (e.g., the space) 920 with the visual indicator 930 therein, according to an embodiment. The 2D ribbon (e.g., the space) 920 and/or the visual indicator 930 are shown here in a solid curve render style, according to an embodiment.

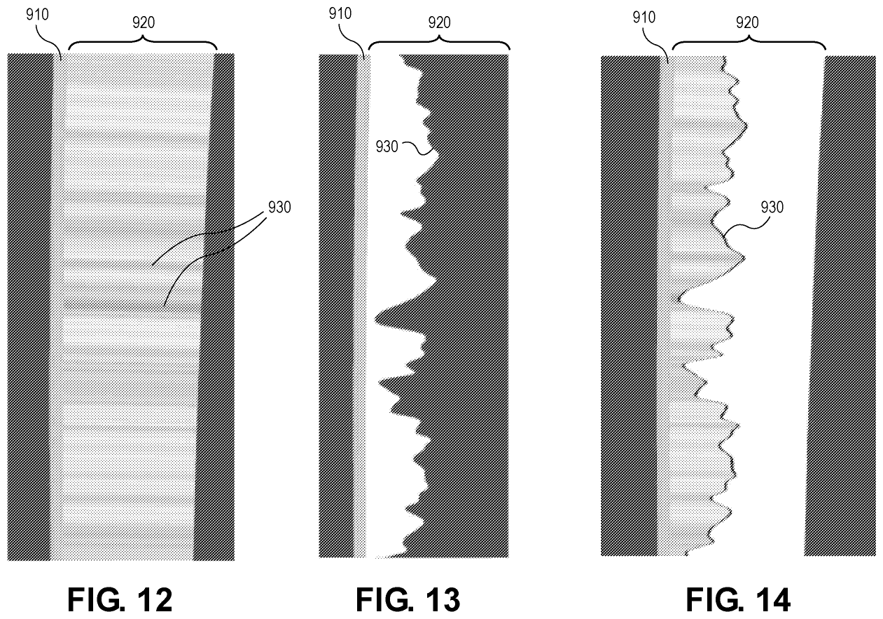

FIG. 14 illustrates the first line 910 and the 2D ribbon (e.g., the space) 920 with the visual indicator 930 therein, according to an embodiment. The 2D ribbon (e.g., the space) 920 and/or the visual indicator 930 are shown here in combined render styles, according to an embodiment.

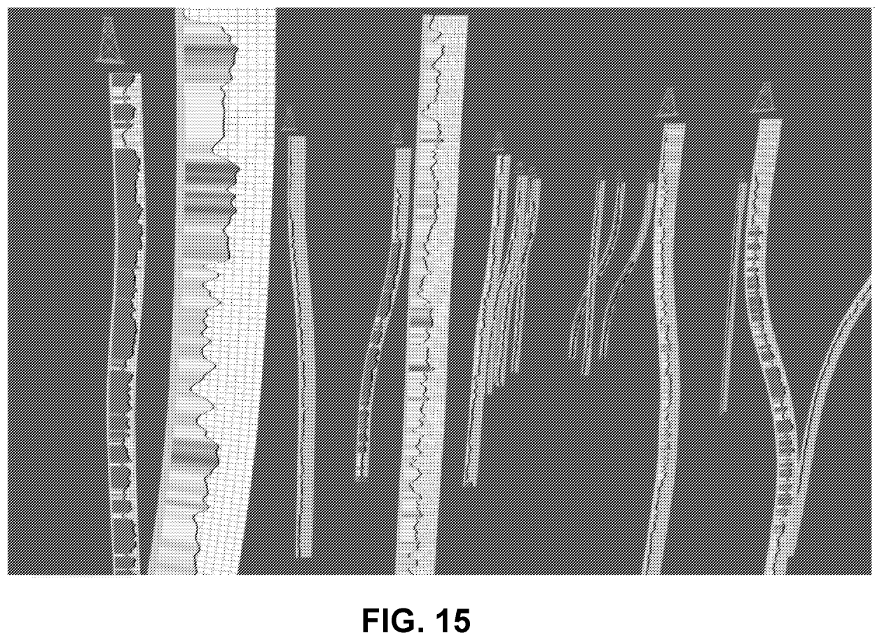

FIG. 15 illustrates a plurality of 3D wellbore trajectories with each having a corresponding 2D ribbon next to it, according to an embodiment. As mentioned above, the method 600 is described using well log data 410 from a single wellbore 700 to generate a single first line 910 and a single ribbon 920 with the visual indicator 930 therein. However, the method 600 may also or instead use well log data 410 from a plurality of wellbores 700 to generate a plurality of first lines 910 and a plurality of corresponding ribbons 920 with visual indicators 930 therein.

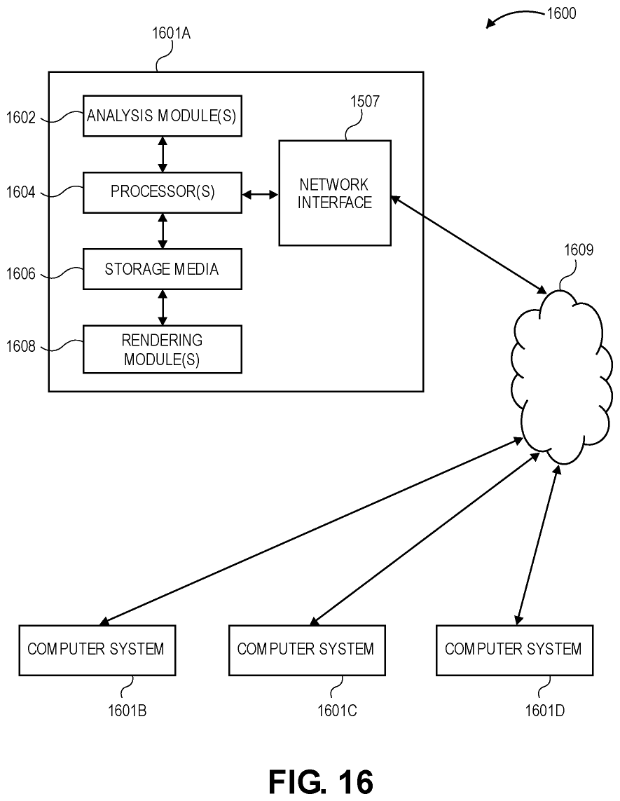

In some embodiments, any of the methods of the present disclosure may be executed by a computing system. FIG. 16 illustrates an example of such a computing system 1600, in accordance with some embodiments. The computing system 1600 may include a computer or computer system 1601A, which may be an individual computer system 1601A or an arrangement of distributed computer systems. The computer system 1601A includes one or more analysis module(s) 1602 configured to perform various tasks according to some embodiments, such as one or more methods disclosed herein. To perform these various tasks, the analysis module 1602 executes independently, or in coordination with, one or more processors 1604, which is (or are) connected to one or more storage media 1606. The processor(s) 1604 is (or are) also connected to a network interface 1607 to allow the computer system 1601A to communicate over a data network 1609 with one or more additional computer systems and/or computing systems, such as 1601B, 1601C, and/or 1601D (note that computer systems 1601B, 1601C and/or 1601D may or may not share the same architecture as computer system 1601A, and may be located in different physical locations, e.g., computer systems 1601A and 1601B may be located in a processing facility, while in communication with one or more computer systems such as 1601C and/or 1601D that are located in one or more data centers, and/or located in varying countries on different continents).

A processor can include a microprocessor, microcontroller, processor module or subsystem, programmable integrated circuit, programmable gate array, or another control or computing device.

The storage media 1606 can be implemented as one or more computer-readable or machine-readable storage media. Note that while in the example embodiment of FIG. 16 storage media 1606 is depicted as within computer system 1601A, in some embodiments, storage media 1606 may be distributed within and/or across multiple internal and/or external enclosures of computing system 1601A and/or additional computing systems. Storage media 1606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1600 contains one or more seismic processing module(s) 1608 that may perform at least a portion of one or more of the method(s) described above. It should be appreciated that computing system 1600 is only one example of a computing system, and that computing system 1600 may have more or fewer components than shown, may combine additional components not depicted in the example embodiment of FIG. 16, and/or computing system 1600 may have a different configuration or arrangement of the components depicted in FIG. 16. The various components shown in FIG. 16 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an iterative basis, such as at a computing device (e.g., computing system 1600, FIG. 16), and/or through manual control by a user who may make determinations regarding whether a given step, action, template, model, or set of curves has become sufficiently accurate for the evaluation of the subterranean three-dimensional geologic formation under consideration.

The following clauses set out some embodiments of the invention:
Clause 1: A method includes receiving well log data with a central processing unit (CPU). The well log data is captured by a downhole tool in a wellbore. The well log data includes a first parameter and a second parameter. The first parameter is a trajectory of the wellbore. The method also includes transmitting the well log data from the CPU to a graphics processing unit (GPU). The method also includes generating a line representing the trajectory of the wellbore using the GPU. The line is based upon the first parameter. The method also includes generating a ribbon using the GPU based upon the first parameter and the second parameter.
Clause 2: The method of clause 1, wherein the second parameter includes temperature, pressure, resistivity, porosity, gamma ray, sonic velocity, or a combination thereof.
Clause 3: The method of clause 1 or clause 2, wherein the CPU does not generate a texture or a model based upon the well log data before transmitting the well log data to the GPU, thereby reducing an amount of memory used by the GPU.
Clause 4: The method of any of clauses 1-3, wherein generating the ribbon includes generating a space using a geometry shader running on the GPU, wherein the space is adjacent to the line, and wherein the space is based upon the first parameter.
Clause 5: The method of any of clauses 1-4, wherein generating the ribbon includes generating a visual indicator using a fragment shader running on the GPU, and wherein the visual indicator is based upon the second parameter.
Clause 6: The method of clause 5, wherein generating the visual indicator includes determining corresponding coordinates in a ribbon coordinate system for a pixel in the space.
Clause 7: The method of clause 6, wherein generating the visual indicator further includes determining a measured depth of the pixel and a value of the pixel in the space based upon the corresponding coordinates in the ribbon coordinate system.
Clause 8: The method of clause 7, wherein generating the visual indicator further includes determining a value of the second parameter for the pixel based upon the measured depth of the pixel and the value of the pixel in the space.
Clause 9: The method of clause 8, wherein generating the visual indicator further includes generating a color for the pixel based at least partially upon the value of the second parameter, wherein generating the color includes generating a first color that forms a part of the visual indicator, generating a second color that does not form the part of the visual indicator, or both.
Clause 10: The method of clause 9, wherein the color is generated based upon a comparison of the value of the pixel and the value of the second parameter.
Clause 11: A computing system includes one or more processors and a memory system including one or more non-transitory computer-readable media storing instructions that, when executed by at least one of the one or more processors, cause the computing system to perform operations. The operations include receiving well log data with a central processing unit (CPU). The well log data is captured by a downhole tool in a wellbore. The well log data includes a first parameter and a second parameter. The first parameter is a trajectory of the wellbore. The second parameter includes temperature, pressure, resistivity, porosity, gamma ray, sonic velocity, or a combination thereof in the wellbore. The operations also include transmitting the well log data from the CPU to a graphics processing unit (GPU). The operations also include generating a line representing the trajectory of the wellbore using the GPU. The line is based upon the first parameter. The operations also include generating a two-dimensional (2D) ribbon using the GPU. Generating the 2D ribbon includes generating a space using a geometry shader running on the GPU. The space is adjacent to the line. The space is determined based upon the first parameter. Generating the 2D ribbon also includes generating a visual indicator using a fragment shader running on the GPU. The visual indicator is positioned within the space. The visual indicator is based upon the second parameter.
Clause 12: The computing system of clause 11, wherein the CPU does not generate a texture or a model based upon the well log data before transmitting the well log data to the GPU, thereby reducing an amount of memory used by the GPU.
Clause 13: The computing system of clause 11 or clause 12, wherein a top left foremost point of the space has first coordinates (0, 0) in a ribbon coordinate system, wherein a bottom right foremost point has second coordinates (maxMD, max Value) in the ribbon coordinate system, wherein maxMD is a maximum measured depth of the wellbore, and wherein max Value is a maximum value of the second parameter.
Clause 14: The computing system of any of clauses 11-13, wherein generating the visual indicator includes: determining corresponding coordinates in a ribbon coordinate system for a pixel in the space; determining a measured depth of the pixel and a value of the pixel in the space based upon the corresponding coordinates in the ribbon coordinate system; determining a value of the second parameter for the pixel based upon the measured depth of the pixel and the value of the pixel in the space; and generating a color for the pixel based at least partially upon the value of the second parameter, wherein generating the color includes generating a first color that forms a part of the visual indicator, generating a second color that does not form the part of the visual indicator, or both.
Clause 15: The computing system of clause 14, wherein the color is generated based upon a comparison of the value of the pixel and the value of the second parameter at the measured depth of the pixel.
Clause 16: A computer program includes instruction that, when executed by a computer processor of a computing device, cause the computing device to perform operations. The operations include receiving well log data with a central processing unit (CPU). The well log data is captured by one or more downhole tools in a plurality of wellbores. The well log data includes a first parameter and a second parameter. The first parameter includes trajectories of the wellbores. The second parameter includes temperature, pressure, resistivity, porosity, gamma ray, sonic velocity, or a combination thereof in the wellbores. The operations also include transmitting the well log data from the CPU to a graphics processing unit (GPU). The CPU does not generate a texture or a model based upon the well log data before transmitting the well log data to the GPU, thereby reducing an amount of memory used by the GPU. The operations also include generating a plurality of first lines representing the trajectories of the wellbores using the GPU. The first lines are based upon the first parameter. The operations also include generating a plurality of two-dimensional (2D) ribbons using the GPU. Generating the 2D ribbons includes generating a plurality of spaces using a geometry shader running on the GPU. Each space is adjacent to a corresponding one of the first lines. The spaces are determined based upon the first parameter. A top left foremost point of each space has first coordinates (0, 0) in a ribbon coordinate system. A bottom right foremost point of each space has second coordinates (maxMD, max Value) in the ribbon coordinate system. The variable maxMD is a maximum measured depth, and the variable max Value is a maximum value of the second parameter. Generating the 2D ribbons also includes generating a plurality of second lines using a fragment shader running on the GPU. Each second line is positioned within a corresponding one of the spaces. The second lines are based upon the second parameter. Generating each second line includes determining corresponding coordinates in the ribbon coordinate system for a pixel in the space. Generating each second line also includes determining a measured depth of the pixel and a value of the pixel in the space based upon the corresponding coordinates in the ribbon coordinate system. Generating each second line also includes determining a value of the second parameter for the pixel based upon the measured depth of the pixel and the value of the pixel in the space. Generating each second line also includes generating a color for the pixel based upon a comparison of the value of the pixel and the value of the second parameter at the measured depth of the pixel. Generating the color includes generating a first color in response to the value of the pixel being equal to the value of the second parameter or generating a second color in response to the value of the pixel being different than the value of the second parameter. The first color forms a part of the second line. The second color does not form the part of the second line.
Clause 17: The computer program of clause 16, wherein the amount of memory used by the GPU to process the well log data for one of the plurality of wellbores is less than 100 kilobytes (KB).
Clause 18: The computer program of clause 16 or clause 17, wherein the well log data is captured by the one or more downhole tools in at least 100 wellbores, and wherein the amount of memory used by the GPU is less than 1 gigabyte (GB).
Clause 19: The computer program of any of clauses 16-18, wherein the plurality of first lines are generated simultaneously, and wherein the plurality of 2D ribbons are generated simultaneously.
Clause 20: The computer program of any of clauses 16-19, further including displaying the plurality of first lines and the plurality of 2D ribbons.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving well log data with a central processing unit (CPU), the well log data is captured by a downhole tool in a wellbore, the well log data includes a first parameter and a second parameter, and the first parameter includes a trajectory of the wellbore;
transmitting the well log data from the CPU to a graphics processing unit (GPU);
generating a line representing the trajectory of the wellbore using the GPU, the line is based upon the first parameter; and
generating a ribbon using the GPU based upon the first parameter and the second parameter.

2. The method of claim 1, wherein the second parameter includes temperature, pressure, resistivity, porosity, gamma ray, sonic velocity, or a combination thereof.

3. The method of claim 1, wherein the CPU does not generate a texture or a model based upon the well log data before transmitting the well log data to the GPU.

4. The method of claim 1, wherein generating the ribbon includes generating a space using a geometry shader running on the GPU, the space is adjacent to the line, and the space is based upon the first parameter.

5. The method of claim 1, wherein generating the ribbon includes generating a visual indicator using a fragment shader running on the GPU, and the visual indicator is based upon the second parameter.

6. The method of claim 5, wherein generating the visual indicator includes determining corresponding coordinates in a ribbon coordinate system for a pixel in the space.

7. The method of claim 6, wherein generating the visual indicator includes determining a measured depth of the pixel and a value of the pixel in the space based upon the corresponding coordinates in the ribbon coordinate system.

8. The method of claim 7, wherein generating the visual indicator includes determining a value of the second parameter for the pixel based upon the measured depth of the pixel and the value of the pixel in the space.

9. The method of claim 8, wherein generating the visual indicator includes generating a color for the pixel based at least partially upon the value of the second parameter, generating the color includes generating a first color that forms a part of the visual indicator, generating a second color that does not form the part of the visual indicator.

10. The method of claim 9, wherein the color is generated based upon a comparison of the value of the pixel and the value of the second parameter.

11. A computing system, comprising:
one or more processors; and
a memory system including one or more non-transitory computer-readable media storing instructions that, when executed by at least one of the one or more processors, cause the computing system to perform operations, the operations including:
receiving well log data with a central processing unit (CPU), the well log data is captured by a downhole tool in a wellbore, the well log data includes a first parameter and a second parameter, the first parameter includes a trajectory of the wellbore, and the second parameter includes temperature, pressure, resistivity, porosity, gamma ray, sonic velocity, or a combination thereof in the wellbore;
transmitting the well log data from the CPU to a graphics processing unit (GPU);
generating a line representing the trajectory of the wellbore using the GPU, the line is based upon the first parameter; and
generating a two-dimensional (2D) ribbon using the GPU, wherein generating the 2D ribbon includes:
generating a space using a geometry shader running on the GPU, the space is adjacent to the line, and the space is determined based upon the first parameter; and
generating a visual indicator using a fragment shader running on the GPU, the visual indicator is positioned within the space, the visual indicator is based upon the second parameter.

12. The computing system of claim 11, wherein the CPU does not generate a texture or a model based upon the well log data before transmitting the well log data to the GPU.

13. The computing system of claim 11, wherein a top left foremost point of the space has first coordinates (0, 0) in a ribbon coordinate system, a bottom right foremost point has second coordinates (maxMD, max Value) in the ribbon coordinate system, maxMD is a maximum measured depth of the wellbore, and max Value is a maximum value of the second parameter.

14. The computing system of claim 11, wherein generating the visual indicator includes:
determining corresponding coordinates in a ribbon coordinate system for a pixel in the space;
determining a measured depth of the pixel and a value of the pixel in the space based upon the corresponding coordinates in the ribbon coordinate system;
determining a value of the second parameter for the pixel based upon the measured depth of the pixel and the value of the pixel in the space; and
generating a color for the pixel based at least partially upon the value of the second parameter, generating the color includes generating a first color that forms a part of the visual indicator, generating a second color that does not form the part of the visual indicator.

15. The computing system of claim 14, wherein the color is generated based upon a comparison of the value of the pixel and the value of the second parameter at the measured depth of the pixel.

16. A computer program comprising instructions that, when executed by a computer processor of a computing device, causes the computing device to perform operations, the operations comprising:
receiving well log data with a central processing unit (CPU), the well log data is captured by one or more downhole tools in a plurality of wellbores, the well log data includes a first parameter and a second parameter, the first parameter includes trajectories of the wellbores, and the second parameter includes temperature, pressure, resistivity, porosity, gamma ray, sonic velocity, or a combination thereof in the wellbores;
transmitting the well log data from the CPU to a graphics processing unit (GPU), wherein the CPU does not generate a texture or a model based upon the well log data before transmitting the well log data to the GPU, thereby reducing an amount of memory used by the GPU;
generating a plurality of first lines representing the trajectories of the wellbores using the GPU, wherein the first lines are based upon the first parameter; and
generating a plurality of two-dimensional (2D) ribbons using the GPU, wherein generating the 2D ribbons includes:
generating a plurality of spaces using a geometry shader running on the GPU, each space is adjacent to a corresponding one of the first lines, the spaces are determined based upon the first parameter, a top left foremost point of each space has first coordinates (0, 0) in a ribbon coordinate system, a bottom right foremost point of each space has second coordinates (maxMD, max Value) in the ribbon coordinate system, wherein maxMD is a maximum measured depth, and wherein max Value is a maximum value of the second parameter; and
generating a plurality of second lines using a fragment shader running on the GPU, each second line is positioned within a corresponding one of the spaces, the second lines are based upon the second parameter, and generating each second line includes:
determining corresponding coordinates in the ribbon coordinate system for a pixel in the space;
determining a measured depth of the pixel and a value of the pixel in the space based upon the corresponding coordinates in the ribbon coordinate system;
determining a value of the second parameter for the pixel based upon the measured depth of the pixel and the value of the pixel in the space; and
generating a color for the pixel based upon a comparison of the value of the pixel and the value of the second parameter at the measured depth of the pixel, generating the color includes generating a first color in response to the value of the pixel being equal to the value of the second parameter or generating a second color in response to the value of the pixel being different than the value of the second parameter, the first color forms a part of the second line, and the second color does not form the part of the second line.

17. The computer program of claim 16, wherein the amount of memory used by the GPU to process the well log data for one of the plurality of wellbores is less than 100 kilobytes (KB).

18. The computer program of claim 16, wherein the well log data is captured by the one or more downhole tools in at least 100 wellbores, and wherein the amount of memory used by the GPU is less than 1 gigabyte (GB).

19. The computer program of claim 16, wherein the plurality of first lines are generated simultaneously, and the plurality of 2D ribbons are generated simultaneously.

20. The computer program of claim 16, further including displaying the plurality of first lines and the plurality of 2D ribbons.
